(19) United States
(12) Patent Application Publication
(10) Pub. No.: US 2026/0180402 A1
(43) Pub. Date: Jun. 25, 2026

(54) MOTOR SYSTEM

(71) Applicant: MAZDA MOTOR CORPORATION, Hiroshima (JP)

(72) Inventors: Shun OSAWA, Aki-gun (JP); Yoshitomo TAKAHASHI, Aki-gun (JP)

(73) Assignee: MAZDA MOTOR CORPORATION, Hiroshima (JP)

(21) Appl. No.: 19/411,500

(22) Filed: Dec. 8, 2025

(30) Foreign Application Priority Data
Dec. 25, 2024 (JP) 2024-228634

(51) Int. Cl. H02K 9/193; F16J 15/16; H02K 5/124; H02K 5/20; H02K 11/25

(52) U.S. Cl. CPC H02K 9/193; F16J 15/162; H02K 5/124; H02K 5/203; H02K 11/25

(57) ABSTRACT

A motor system for cooling a mechanical seal provided for a rotating shaft of a motor includes the mechanical seal; a coolant channel that guides a coolant to the vicinity of the mechanical seal; and a refrigerant circulation circuit that circulates a refrigerant in the motor and cools the motor, in a casing, a cooling jacket passage is formed which is for causing the coolant to flow passing through the vicinity of a fixed ring and/or a secondary seal, and the coolant channel has a coolant heat exchange unit for performing heat exchange between the coolant in the coolant channel and the refrigerant in the refrigerant circulation circuit and is configured to guide the coolant, which is cooled by the coolant heat exchange unit, to at least the cooling jacket passage.

### CROSS-REFERENCE TO RELATED APPLICATION

The present application claims priority to Japanese Patent Application 2024-228634, filed Dec. 25, 2024, the entire contents of which are incorporated herein by reference.

### FIELD

Embodiments relate to a motor system, particularly to a motor system for cooling a sealing member of a rotating shaft of an electric motor.

### BACKGROUND

A configuration has been suggested which uses a mechanical seal for a shaft penetration portion of an electric motor for motive power (see Patent Literature 1). In general, a mechanical seal is configured such that two annular members (a seal ring and a mating ring) slide in a state where those are pressed onto each other in an axis direction. Thus, because temperatures of the annular members rise due to frictional heat produced on sliding surfaces, the annular members are formed with a material with a high thermal resistant temperature (for example, a ceramic-based material).

Meanwhile, a secondary seal (such as an O ring or a bracket) which configures a part of the mechanical seal is used for mounting the annular members on a structure body (such as a housing or a cover member) or a rotating shaft. The secondary seal can absorb deformation and vibration of a motor system. The secondary seal is formed with a material (such as rubber or a resin, for example) whose thermal resistant temperature is low compared to those of materials which form the structure body (for example, an iron-based material) and the annular members (for example, a ceramic-based material).

Further, in recent years, accompanying attainment of high rotation (for example, exceeding 30,000 rpm) of the electric motor for motive power which is installed in a vehicle, in a case where the mechanical seal is used for such a high rotation motor, a circumferential speed or a rotational speed in a sliding portion of the mechanical member becomes a higher speed. In this case, greater heat is produced in the mechanical seal.

### CITATION LIST

### Patent Literature

[Patent Literature 1] Japanese Patent Laid-Open No. 2022-18909

### SUMMARY

However, in a structure disclosed in Patent Literature 1, because a part of annular members, which are exposed in a motor chamber, in a mechanical seal is cooled by a coolant, it might not be possible to efficiently cool a secondary seal. In particular, as for a high rotation motor in which greater heat is produced in a sliding portion, in the structure disclosed in Patent Literature 1, a temperature of the secondary seal might exceed a thermal resistant temperature. Thus, in the structure in related art, durability of the whole mechanical seal (particularly, the secondary seal) might be impaired.

The embodiments have been made for solving the above-described technical problems, and an embodiment may provide a motor system that is capable of effectively cooling a mechanical seal.

To achieve the cooling, the embodiments provide a motor system for cooling a mechanical seal provided for a rotating shaft of a motor, the motor system including: a mechanical seal that has a rotating ring mounted on the rotating shaft and a fixed ring fixed to a casing of the motor via a secondary seal and that is configured such that the rotating ring and the fixed ring abut each other at predetermined pressure in an axis direction of the rotating shaft; a tank for storing a coolant to be supplied to the mechanical seal; a pump for pressure-feeding the coolant stored in the tank; a coolant channel that guides the coolant, which is pressure-fed by the pump, to a vicinity of the mechanical seal; and a refrigerant circulation circuit that circulates a refrigerant in the motor and cools the motor, characterized in that in the casing, a cooling jacket passage is formed which is for causing the coolant to flow passing through a vicinity of the fixed ring and/or the secondary seal, and the coolant channel has a coolant heat exchange unit for performing heat exchange between the coolant in the coolant channel and the refrigerant in the refrigerant circulation circuit and is configured to guide the coolant, which is cooled by the coolant heat exchange unit, to at least the cooling jacket passage.

In the embodiment configured in such a manner, a configuration is made such that the cooling jacket passage which causes the coolant to pass therethrough for cooling the mechanical seal is formed in the casing and the casing functions as a cooling jacket. In addition, in the embodiments, a configuration is made such that in the coolant heat exchange unit, the coolant, which has been cooled by the refrigerant in the refrigerant circulation circuit for cooling the motor is guided to the cooling jacket passage. In such a configuration, in the embodiments, the mechanical seal can effectively be cooled, and degradation of the mechanical seal can be inhibited.

Further, in the embodiments, the coolant channel may be configured to guide the coolant to the cooling jacket passage and to blow the coolant onto the mechanical seal. In the embodiments configured in such a manner, cooling and lubrication of the mechanical seal can be performed by the coolant.

Further, in the embodiments, the cooling jacket passage may have an entrance passage which extends from an inner side surface of the casing along the axis direction and receives the coolant; a cooling passage which communicates with the entrance passage, extends around the rotating shaft in the casing, and causes the coolant to pass through the cooling passage; and an exit passage which communicates with the cooling passage and is for discharging the coolant from the cooling passage. In the embodiments configured in such a manner, while stress concentration which can occur in the casing is inhibited by formation of the cooling jacket passage, the mechanical seal mounted on the casing can be cooled by the coolant which passes through the cooling jacket passage.

Further, in the embodiments, the coolant may be lubricating oil. In the embodiments configured in such a manner, because the coolant for lubrication and cooling of the mechanical seal can be supplied to the mechanical seal by using a common channel, a device configuration can be simplified.

Further, in the embodiments, the refrigerant may be a CO₂ refrigerant. In the embodiments configured in such a manner, an environmental load can be decreased by using a natural refrigerant.

Further, in the embodiments, the refrigerant may be, together with the coolant, stored in the tank, and the refrigerant circulation circuit may include a compressor which compresses the refrigerant supplied from the tank, a heat exchanger which causes the compressed refrigerant to dissipate heat, and an expansion valve which expands the refrigerant resulting from heat dissipation and may be configured to supply the expanded refrigerant to the motor and the coolant heat exchange unit. In the embodiments configured in such a manner, the refrigerant in a low temperature state can be generated by the refrigerant circulation circuit, and the coolant can effectively be cooled in the coolant heat exchange unit.

Further, in the embodiments, the expansion valve may include at least a first expansion valve and a second expansion valve, and the refrigerant circulation circuit may branch into the first expansion valve and the second expansion valve in a downstream portion relative to the heat exchanger and may be configured such that the refrigerant expanded by the first expansion valve is supplied to the motor and the refrigerant expanded by the second expansion valve is supplied to the coolant heat exchange unit. In the embodiments configured in such a manner, cooling of the motor and cooling of the coolant in the coolant heat exchange unit can effectively be performed.

Further, in the embodiments, the coolant channel may include a first branch channel which passes through the coolant heat exchange unit, a second branch channel which bypasses the coolant heat exchange unit, and a switching valve which selectively switches the first branch channel and the second branch channel, the motor system may further include a temperature sensor that measures a temperature of the mechanical seal and a controller that controls the switching valve, and the controller may be configured to control the switching valve such that the coolant passes through the first branch channel in a case where the temperature measured by the temperature sensor is equal to or higher than a predetermined threshold value temperature. In the embodiments configured in such a manner, when the temperature of the mechanical seal is low and cooling of the coolant by the refrigerant is not necessary, an operation load of the refrigerant circulation circuit is reduced, and power saving can thereby be achieved.

### Advantageous Effects

A motor system according to an embodiment can sufficiently cool a mechanical seal.

### BRIEF DESCRIPTION OF DRAWINGS

FIG. 1 is an outline configuration diagram of a motor system according to an embodiment.

FIG. 2 is an electric block diagram of the motor system according to the embodiment.

FIG. 3 is an explanatory diagram of a refrigeration cycle of the motor system according to the embodiment.

FIG. 4 is a cross-sectional view illustrating a mounting structure of a mechanical seal according to the embodiment.

FIG. 5 is a partial cross-sectional perspective view of an end cover according to the embodiment.

FIG. 6 is an arrow view along line VI-VI in FIG. 5.

FIG. 7 is a partial cross-sectional perspective view of a casing according to the embodiment.

FIG. 8 is a flowchart illustrating a processing flow of the motor system according to the embodiment.

FIG. 9 is a graph illustrating a relationship between a motor speed and a temperature of the mechanical seal.

FIG. 10 is a time chart of various physical quantities accompanying the processing flow of the motor system according to the embodiment.

FIG. 11 is a partial cross-sectional perspective view of an end cover according to a modification example of the embodiment.

FIG. 12 is a cross-sectional view illustrating a mounting structure of a mechanical seal according to a modification example of the embodiment.

### DETAILED DESCRIPTION

A motor system according to embodiments will hereinafter be described with reference to the attached drawings.

### Configuration of System

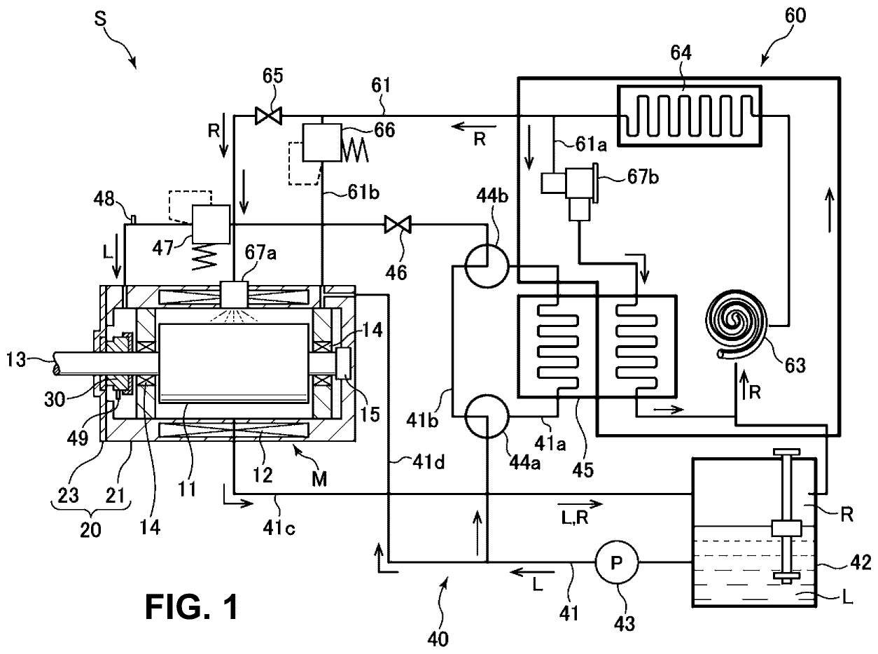

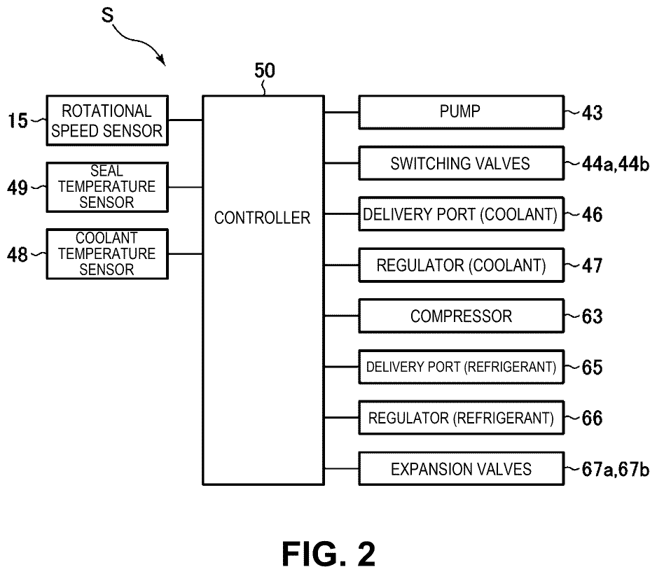

First, a general configuration of a motor system S according to the present embodiment will be described with reference to FIG. 1 and FIG. 2. FIG. 1 is an outline configuration diagram of the motor system according to the present embodiment, and FIG. 2 is an electric block diagram of the motor system. The motor system S illustrated in FIG. 1 is configured to execute supply of coolant to a mechanical seal which is incorporated in a motor M used for driving of a vehicle such as an electric automobile and supply of a refrigerant to the motor M (particularly, a stator and a rotor), for example.

Thus, the motor system S includes a coolant circulation circuit 40 for circulating a coolant L in a mechanical seal 30 and thereby cooling the mechanical seal 30 and a refrigerant circulation circuit 60 for circulating a refrigerant R in the motor M and thereby cooling the motor M. In the present embodiment, the coolant L and the refrigerant R are different fluids, the coolant L is lubricating oil, for example, and the refrigerant R is a natural refrigerant such as a CO₂ refrigerant, for example.

Various kinds of configuration elements are arranged on piping (or channel) 41, and the coolant circulation circuit 40 is thereby configured. On the channel 41, a tank 42 which stores the coolant L, a pump 43 which pressure-feeds the coolant L in the tank 42, two switching valves 44a and 44b, a coolant heat exchange unit 45, an arbitrary delivery valve 46, an arbitrary regulator 47, and the motor M are provided. On a downstream side relative to the regulator 47, a coolant temperature sensor 48 is arranged which measures a coolant temperature TL of the coolant L flowing into the motor M. In addition, in the motor M, a seal temperature sensor 49 is arranged which detects a seal temperature T around the mechanical seal 30.

The channel 41 branches into a first branch channel 41a and a second branch channel 41b between the switching valves 44a and 44b. The first branch channel 41a is a channel for cooling in which the coolant heat exchange unit 45 is arranged. The second branch channel 41b is a channel for bypassing. Each of the switching valves 44a and 44b is configured to selectively operate in conjunction with a valve position for cooling (cooling position) and a valve position for bypassing (bypassing position). Each of the switching valves 44a and 44b causes the coolant L to be pressure-fed from the pump 43 to pass through the first branch channel 41a at the cooling position and to pass through the second branch channel 41b at the bypassing position. Note that each of the switching valves 44a and 44b may usually be set to the bypassing position.

The coolant heat exchange unit 45 is configured to perform heat exchange between the refrigerant R, which flows through the refrigerant circulation circuit 60, and the coolant L and to thereby cool the coolant L. That is, in the coolant heat exchange unit 45, heat exchange is performed while the coolant L and the refrigerant R are passing through separate pieces of piping, and the coolant L is thereby cooled by the refrigerant R at a low temperature.

The delivery valve 46 is an opening-closing valve which opens and closes the channel 41 and switches sending and stop of the coolant L. The regulator 47 is a pressure regulating valve, reduces a sending pressure by the pump 43 to predetermined pressure, and thereby regulates a flow amount.

In the coolant circulation circuit 40, the coolant L is supplied by the pump 43 from an inside of the tank 42 toward a downstream portion of the channel 41. The coolant L passes through the first branch channel 41a or the second branch channel 41b, is thereafter supplied into the motor M, and cools the mechanical seal 30 in the motor M. The coolant L which has cooled the mechanical seal 30 passes, from a discharge portion of the motor M, through a channel 41c for discharge and returns to the tank 42.

Note that the channel 41 arbitrarily has a lubrication branch channel 41d which branches in a downstream portion relative to the pump 43. The coolant L (lubricating oil) which flows through the lubrication branch channel 41d is supplied to bearings 14 of the motor M without flowing toward the switching valve 44a. The coolant L which has lubricated the bearings 14 flows, together with the coolant L which has cooled the mechanical seal 30, from the discharge portion into the channel 41c.

The refrigerant circulation circuit 60 is configured to share a part of configuration elements with the coolant circulation circuit 40. The refrigerant circulation circuit 60 forms a refrigeration cycle with the refrigerant R (CO₂ refrigerant) and includes, on piping (or channel) 61, the tank 42 which stores the coolant L and the refrigerant R, a compressor 63 which compresses the refrigerant R, a heat exchanger (condensing device) 64 which includes a condenser, a fan, and so forth, an arbitrary delivery valve 65, an arbitrary regulator 66, an expansion valve 67a (first expansion valve), an arbitrary expansion valve 67b (second expansion valve), and the motor M and the coolant heat exchange unit 45 which serve as an evaporator.

The tank 42 is configured to store both of the coolant L and the refrigerant R, and in the tank 42, the coolant L (lubricating oil) as a liquid and the refrigerant R (CO₂ refrigerant) as gas are separated in an up-down direction. Consequently, in the coolant circulation circuit 40, the coolant L can be taken out from a lower portion of the tank 42, and in the refrigerant circulation circuit 60, the refrigerant R can be taken out from an upper portion of the tank 42.

In the present embodiment, the channel 61 includes a branch channel 61a, the branch channel 61a branches from the channel 61 as a main stream in a downstream portion relative to the heat exchanger 64 and merges with the channel 61 between the tank 42 and the compressor 63. The refrigerant R flowing through the branch channel 61a passes through the expansion valve 67b without flowing toward the motor M, flows into the coolant heat exchange unit 45, and performs heat exchange with the coolant L (that is, cools the coolant L).

In the present embodiment, each of the expansion valves 67a and 67b is an electronic expansion valve whose valve opening degree is electronically controllable. The expansion valve 67a can be mounted on the channel 61 or a casing 20. Further, the expansion valve 67a may be of an integrated type which is integrated with the casing 20, and in this case, the expansion valve 67a may be an electronic expansion valve or may be a narrow hole which is mounted on the casing 20.

Note that in the present embodiment, the expansion valve 67b is provided; however, this is not restrictive, the branch channel 61a is provided so as to branch from a downstream portion relative to the expansion valve 67a and to guide the refrigerant R to the coolant heat exchange unit 45, and a configuration may thereby be made which is not provided with the expansion valve 67b.

Further, in the present embodiment, the channel 61 includes another branch channel 61b which branches from the channel 61 as the main stream in a downstream portion relative to the heat exchanger 64. The refrigerant R flowing through the branch channel 61b is depressurized to predetermined pressure by the regulator 66 and thereafter merges with the coolant L flowing through the lubrication branch channel 41d or is separately supplied to the bearings 14 of the motor M. Note that in a case where it is not necessary to cool the bearings 14 by the refrigerant R, a configuration may be made which is not provided with the branch channel 61b or the regulator 66.

In the refrigerant circulation circuit 60, the refrigerant R in the tank 42 passes through the compressor 63, the heat exchanger 64, and the expansion valve 67a, is supplied into the motor M, and cools configuration components (particularly, the stator and the rotor) in the motor M. The refrigerant R which has cooled the motor M passes, from the discharge portion of the motor M, through the channel 41c for discharge and returns to the tank 42, similarly to the coolant L.

### Configuration of Motor

The motor M according to the present embodiment is a high rotational speed motor and is configured to operate at a high rotational speed exceeding 30,000 rpm, for example. The motor M includes a rotor 11, a stator 12, a rotating shaft (rotor shaft) 13 which is fixed to the rotor 11 and extends in an axis direction, a pair of bearings (sliding bearings) 14 which rotatably support the rotating shaft 13, the casing 20 which houses and supports those rotor 11, stator 12, rotating shaft 13, bearings 14, and so forth, and the mechanical seal 30 which seals a portion between the casing 20 and the rotating shaft 13. One end of the rotating shaft 13 is connected to a transaxle or the like of the vehicle. Further, the motor M arbitrarily includes a rotational speed sensor or an angle sensor (resolver) 15 for detecting a rotor rotational speed of the rotating shaft 13. The casing 20 includes a housing 21 which houses the rotor 11 and so forth and an end cover 23 which blocks an opening of an axis-direction end portion of the housing 21.

The stator 12 having a generally cylindrical shape is configured with a coil wound around a stator core. The rotor 11 has a rotor core and a plurality of permanent magnets mounted on the rotor core. The rotating shaft 13 is fixed to the rotor core. The rotor 11 is configured to be rotatable together with the rotating shaft 13 in the stator 12.

The mechanical seal 30 tightly seals a portion between an end portion of the rotating shaft 13 and the end cover 23 and prevents leakage of the refrigerant R and the coolant L from an internal portion of the casing 20 to an outside. Further, in the casing 20, as the channels 41 and 61, an internal channel which receives the coolant L from the outside and guides that to the mechanical seal 30 and the bearings 14, an internal channel which receives the refrigerant R from the outside and guides that to an internal portion of the motor M and the bearings 14, and an internal channel as the discharge portion which guides the coolant L and the refrigerant R to the channel 41c for discharge are formed.

As illustrated in FIG. 2, the motor system S includes a controller 50 as a computer (e.g., a control computer) which has a processor, a memory, and so forth, receives signals (such as a rotor rotation angle, a seal temperature, and a coolant temperature) from various sensors, and outputs an operation signal to each configuration element of the coolant circulation circuit 40 and the refrigerant circulation circuit 60. In the present embodiment, the refrigerant circulation circuit 60 is configured to always operate during an operation of the motor M.

### Refrigeration Cycle by Refrigerant

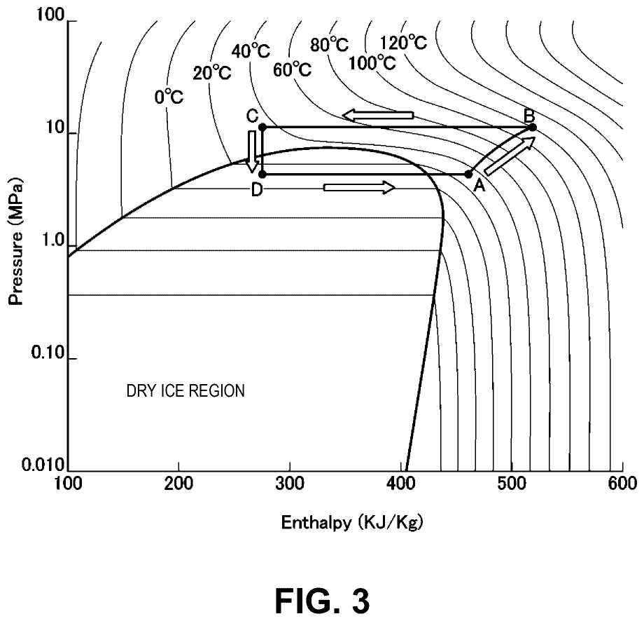

Next, the refrigeration cycle by the refrigerant R in the present embodiment will be described with reference to FIG. 3. FIG. 3 is a p-h chart of the CO₂ refrigerant, the horizontal axis represents enthalpy, and the vertical axis represents pressure. The CO₂ refrigerant becomes a supercritical fluid when pressure and a temperature are raised from an ambient environment (an ordinary temperature and 1 atm) and exceed a critical point (31° C. and 7.4 MPa).

First, in the refrigeration cycle (A-B-C-D) of the present embodiment, a compression step (A-B) by the compressor 63 is performed. The compressor 63 is of a rotary type and receives the CO₂ refrigerant R (gas, superheated vapor) at an intermediate temperature and low pressure (for example, 30° C. and 4.2 MPa) from the tank 42 via the channel 61 (point A), compresses the received refrigerant R, and delivers the CO₂ refrigerant R (supercritical fluid) at a high temperature and high pressure (for example, 120° C. and 12 MPa) (point B).

Next, a cooling step (B-C) by the heat exchanger 64 is performed. The heat exchanger 64 receives the CO₂ refrigerant R at the high temperature and high pressure (point B), performs heat exchange with an external environment (such as cool wind or cooling water), and generates the CO₂ refrigerant R (supercritical fluid) at an intermediate temperature and high pressure (for example, 35° C. and 12 MPa) (point C). Next, an expansion step (C-D) by the expansion valve 67a (or expansion valve 67b) is performed for the CO₂ refrigerant R at the intermediate temperature and high pressure. The CO₂ refrigerant R expands by the expansion step and becomes the CO₂ refrigerant R (gas-liquid mixture, wet vapor) at a low temperature and low pressure (for example, 10° C. and 4.2 MPa) (point D).

In addition, in the internal portion of the motor M (or the coolant heat exchange unit 45), an evaporation step (D-A) is performed. In the casing 20, the CO₂ refrigerant R at the low temperature and low pressure evaporates by performing heat exchange with a high temperature portion of the motor M (or the coolant L in the coolant heat exchange unit 45) and becomes the CO₂ refrigerant R (gas, superheated vapor) at an intermediate temperature and low pressure. This CO₂ refrigerant R at the intermediate temperature and low pressure is returned to the compressor 63 (point A).

### Mounting Structure of Mechanical Seal

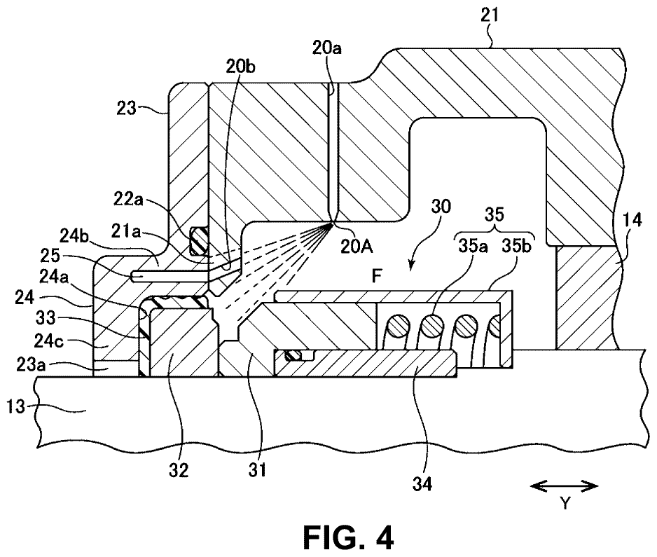

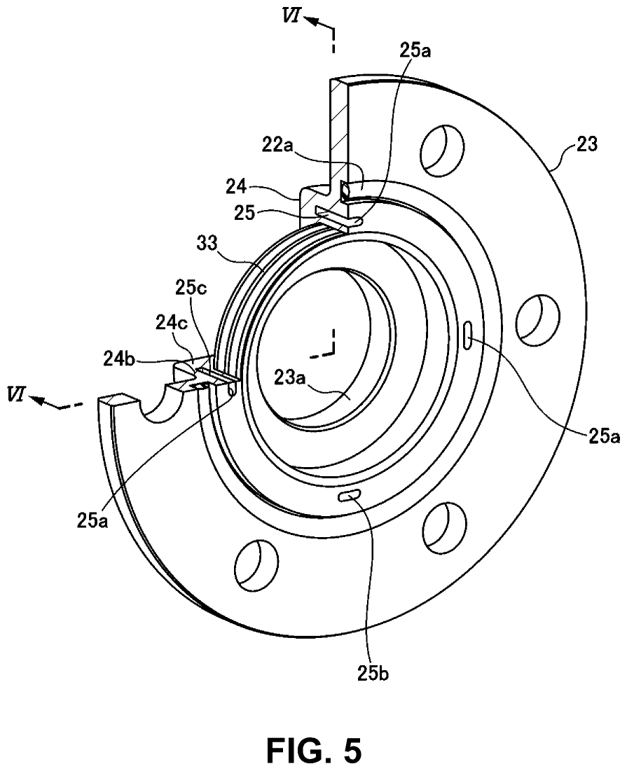

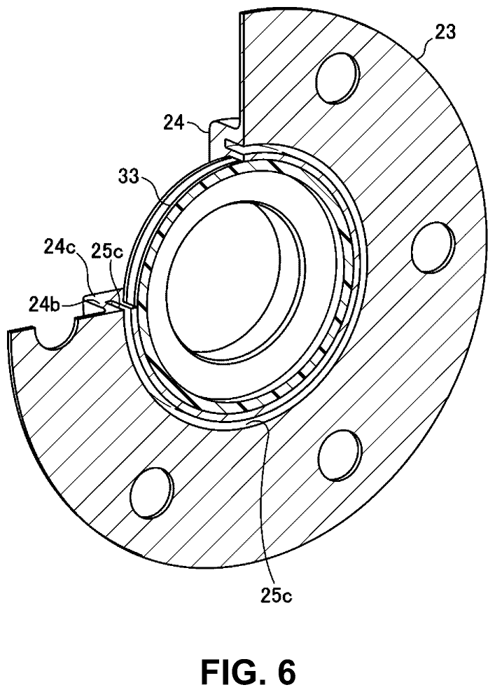

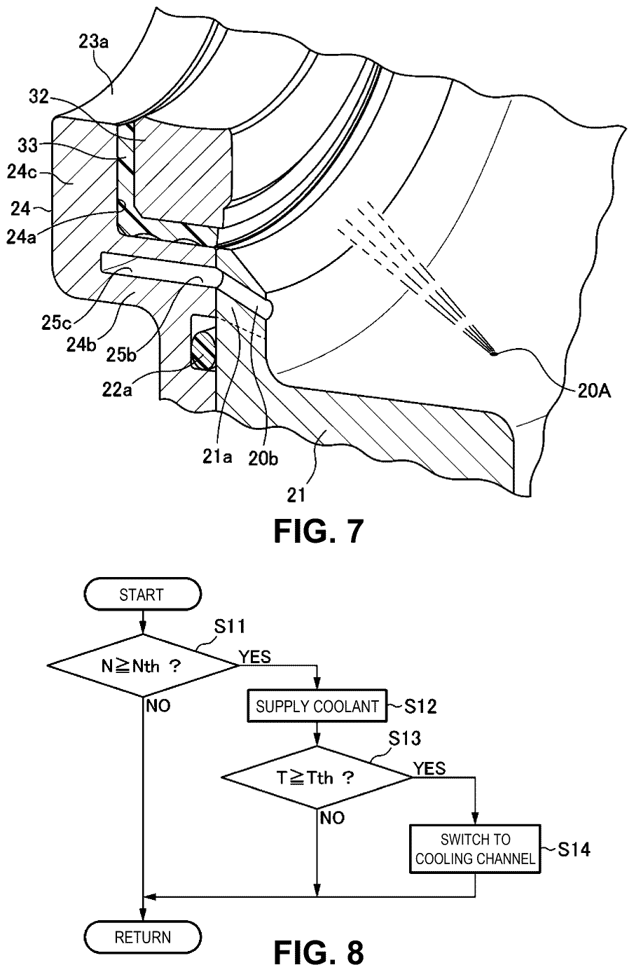

Next, a mounting structure of the mechanical seal according to the present embodiment will be described with reference to FIG. 4 to FIG. 7. FIG. 4 is a cross-sectional view illustrating the mounting structure of the mechanical seal, FIG. 5 is a partial cross-sectional perspective view of the end cover, FIG. 6 is an arrow view along line VI-VI in FIG. 5, and FIG. 7 is a partial cross-sectional perspective view of the casing.

As illustrated in FIG. 4, the end cover 23 is fixed to an end portion of the housing 21, and in an internal portion of the housing 21, the seal arrangement space F in which the rotating shaft 13 extends in an axis direction Y is provided between the bearing 14 and the end cover 23. The mechanical seal 30 is arranged in the seal arrangement space F. The end cover 23 has a disk shape and is screwed to the housing 21, with an O ring 22a interposed therebetween, in a tightly sealing state. The end cover 23 has, in its central portion, a cylindrical bulging portion 24 which protrudes toward an outer side in the axis direction Y. A through hole 23a through which the rotating shaft 13 is inserted is formed in the bulging portion 24, and the bulging portion 24 forms a recess 24a for mounting the mechanical seal 30 in an internal portion. The bulging portion 24 has a peripheral wall 24b which extends from a base portion in the axis direction Y and a torus-shaped (donut-shaped) lid portion 24c which extends from a distal end portion of the peripheral wall 24b toward the rotating shaft 13 on a radial-direction inner side and has the through hole 23a.

The rotating shaft 13 which is rotatably supported by the bearings 14 passes through the seal arrangement space F, passes through the through hole 23a provided in the end cover 23, and extends to the outside of the motor M. The mechanical seal 30 is configured to tightly seal a portion between the seal arrangement space F and the outside of the motor M (particularly, a gap between the rotating shaft 13 and the through hole 23a).

The mechanical seal 30 includes a rotating ring 31 which is mounted on the rotating shaft 13, a secondary seal 33 which is mounted by being fitted into the recess 24a formed in the end cover 23, and a fixed ring 32 which is fixed to the end cover 23 via the secondary seal 33. Each of the rotating ring 31 and the fixed ring 32 is an annular component which has a through hole extending in the axis direction Y and is formed of a material with high wear resistance (for example, a ceramic-based material). The rotating shaft 13 is inserted through those through holes.

The rotating ring 31 is integrated with a cylindrical sliding member 34, which is slidably attached to the rotating shaft 13, and is movable together with the sliding member 34 on the rotating shaft 13 in the axis direction Y. Further, the rotating ring 31 is pressed or urged toward the outside of the motor M in the axis direction Y by an urging member 35 which is fixed to the rotating shaft 13. The urging member 35 has a coil spring 35a which is attached to the rotating shaft 13 and a cylindrical annular member 35b which is fixed to the rotating shaft 13. The coil spring 35a is compressed between the annular member 35b and the rotating ring 31 in the axis direction Y and always presses the rotating ring 31 to the annular member 35b in the axis direction Y. Accordingly, the rotating ring 31 and the fixed ring 32 abut each other with predetermined pressure in the axis direction Y.

The fixed ring 32 is mounted by being fitted into the recess 24a, which is formed in the end cover 23, together with the secondary seal 33. The secondary seal 33 is a component which has a bottomed cylindrical shape and is to be attached to the fixed ring 32, and similarly to the fixed ring 32, a through hole through which the rotating shaft 13 passes is formed in a bottom portion. The secondary seal 33 is formed of a material having predetermined elasticity (such as rubber or a resin, for example). A thermal resistant temperature of the secondary seal 33 is lower than those of ceramic-based materials which form the rotating ring 31 and the fixed ring 32 and a metal-based material (particularly, an iron-based material) which forms the casing 20. The secondary seal 33 tightly seals a portion between the fixed ring 32 and the recess 24a of the end cover 23 and absorbs vibration or the like of the rotating shaft 13.

The rotating ring 31 and the fixed ring 32 contact with each other on their sliding surfaces at predetermined surface pressure by the urging member 35. When the rotating ring 31 rotates together with the rotating shaft 13, the sliding surfaces of the fixed ring 32 and the rotating ring 31 slidably contact with each other in a state where the predetermined surface pressure is exerted. Accordingly, frictional heat is produced in the sliding surfaces, and temperature rises occur in the rotating ring 31 and the fixed ring 32.

Further, in the housing 21, as the channel 41 of the coolant circulation circuit 40, internal channels 20a which guide the coolant L to the seal arrangement space F are formed in a plurality of parts in a circumferential direction. Further, in the housing 21, a plurality of internal channels 20b are formed from the seal arrangement space F toward the bulging portion 24. Meanwhile, in the end cover 23, the cooling jacket passage 25 is formed which is for cooling the fixed ring 32 and the secondary seal 33 by the coolant L which is guided through the internal channels 20a. Consequently, the bulging portion 24 functions as a cooling jacket. In the present embodiment, the cooling jacket passage 25 is formed along the peripheral wall 24b of the bulging portion 24.

Note that in the present embodiment, because the end cover 23 is configured to support the fixed ring 32 and the secondary seal 33, the cooling jacket passage 25 is provided in the end cover 23; however, this is not restrictive, and in a case where the housing 21 is configured to support the fixed ring 32 and the secondary seal 33, the cooling jacket passage 25 can be provided in the housing 21.

As illustrated in FIG. 5 and FIG. 6, the cooling jacket passage 25 has three entrance passages 25a and one exit passage 25b, which are holes communicating or in fluid communication with the internal channels 20b and extending from the base portion (a surface on the seal arrangement space side) in the axis direction Y, and a cooling passage 25c, which communicates with the entrance passages 25a and the exit passage 25b and extends along the peripheral wall 24b at least in the circumferential direction. Note that the cooling passage 25c may be formed to be connected from the peripheral wall 24b to the lid portion 24c. Consequently, the cooling passage 25c extends at least in the circumferential direction of the secondary seal 33 or the rotating shaft 13.

In the present embodiment, among the four holes, the entrance passages 25a are holes as the three holes (12 o'clock, 3 o'clock, and 9 o'clock in a front view) which include the highest position in a perpendicular direction, and the exit passage 25b is a hole at the lowest position (6 o'clock position in the front view) in the perpendicular direction.

In an example illustrated in FIG. 4, the internal channels 20a, which extend from an upper area to a lower area, open to the seal arrangement space F with injection holes 20A whose distal end is thin. Further, in the housing 21, the separate internal channels 20b are formed so as to be continuous from the seal arrangement space F to the peripheral wall 24b of the end cover 23. The injection hole 20A is formed to inject the coolant L with a predetermined directivity.

The coolant L passes through the internal channels 20a, is directionally injected to the mechanical seal 30 (particularly, sliding portions of the rotating ring 31 and the fixed ring 32 and openings of the separate internal channels 20b) in the seal arrangement space F by the injection holes 20A, and thereby lubricates the mechanical seal 30. Further, a part of the coolant L injected from the injection holes 20A passes through the separate internal channels 20b and is guided to the entrance passages 25a formed in the end cover 23.

The coolant L enters the cooling passage 25c from the entrance passages 25a, cools the fixed ring 32 and the secondary seal 33 from the circumferential direction, passes, from the exit passage 25b, through the internal channels 20b, and is again discharged to the seal arrangement space F. Note that as illustrated in FIG. 7, the injection hole 20A is arranged in such a position that the injection hole 20A does not inject the coolant L toward the exit passage 25b (and the internal channels 20b communicating with the exit passage 25b) and is set to have such a directional injection pattern that the injection hole 20A does not inject the coolant L toward the exit passage 25b.

Note that in the present embodiment, the housing 21 blocks, by an annular blocking portion 21a, an axis-direction base portion of the peripheral wall 24b of the bulging portion 24 of the end cover 23, and the separate internal channels 20b are formed in the blocking portion 21a. The separate internal channels 20b communicate with the entrance passages 25a. However, a configuration may be made such that by removing at least a part of the blocking portion 21a, at least a part of the axis-direction base portion of the peripheral wall 24b of the bulging portion 24 is not blocked by the housing 21. In such a configuration, the separate internal channels 20b do not have to be formed.

Note that in the present embodiment, the fixed ring 32 fixed to the casing 20 is the mating ring which does not move in the axis direction Y, and the rotating ring 31 mounted on the rotating shaft 13 is the seal ring which is movable in the axis direction Y; however, this is not restrictive, and a configuration may be made in which the fixed ring 32 is used as the seal ring and the rotating ring 31 is used as the mating ring.

### Control Flow

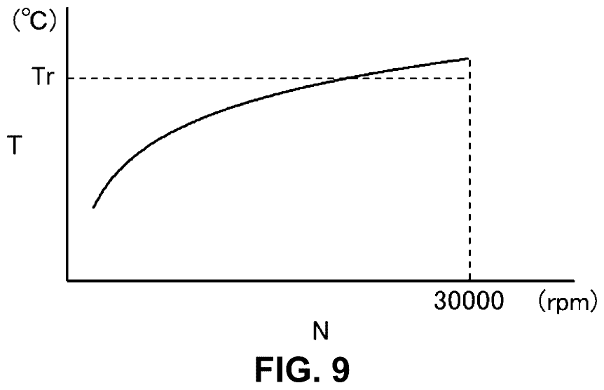

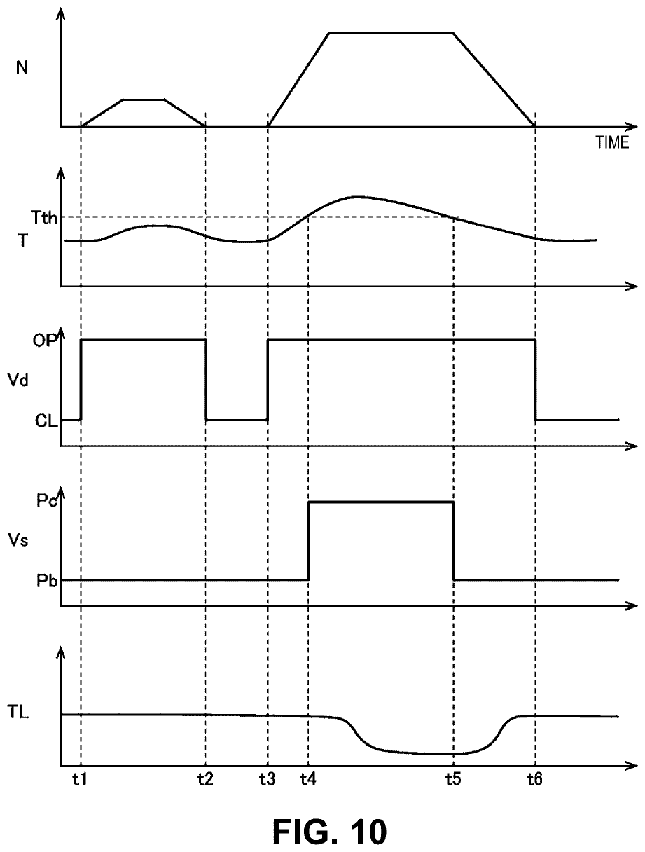

Next, a processing flow of the motor system S of the present embodiment will be described with reference to FIG. 8 to FIG. 10. FIG. 8 is a flowchart illustrating the processing flow of the motor system, FIG. 9 is a graph illustrating a relationship between a motor speed and a temperature of the mechanical seal, and FIG. 10 is a time chart of various physical quantities accompanying the processing flow.

The controller 50 repeatedly performs the processing flow in FIG. 8 for performing cooling of the mechanical seal at predetermined intervals. The controller 50 always receives signals from various sensors and determines whether or not a motor speed N is equal to or higher than a predetermined threshold value rotational speed Nth (S11). Specifically, based on a rotor rotation angle signal received from an angle sensor 15, the controller 50 can calculate the motor speed N of the rotating shaft 13. In the present embodiment, except an extremely low rotational speed which occurs immediately after a start of the motor M and immediately before a stop, the threshold value rotational speed Nth is set such that an affirmative determination is made. The threshold value rotational speed Nth is set in a range of 50 to 100 rpm, for example.

In a case where a negative determination is made in step S11 (No in S11), the controller 50 finishes the process. On the other hand, in a case where an affirmative determination is made in step S11 (Yes in S11), the controller 50 operates the pump 43 and pressure-feeds the coolant L toward the motor M (S12). In this case, the controller 50 maintains the valve position of each of the switching valves 44a and 44b in the valve position for bypassing, causes the coolant L to pass through the second branch channel 41b, retains the delivery valve 46 in an open state, and operates the regulator 47 such that the coolant L is depressurized to predetermined pressure.

Next, the controller 50 determines whether or not the seal temperature T of the mechanical seal 30 is equal to or higher than a predetermined threshold value temperature Tth (S13). In addition, the controller 50 can receive the seal temperature T around the mechanical seal 30 from the seal temperature sensor 49. The threshold value temperature Tth is set lower than a thermal resistant temperature Tr (for example, 150° C.) of the secondary seal 33, whose thermal resistant temperature is low, among configuration components of the mechanical seal 30. The threshold value temperature Tth is set in a range of 50° C. to 140° C., for example, or a temperature range which is lower than the thermal resistant temperature Tr by a predetermined temperature (for example, 100° C. to 10° C.).

The motor M in the present embodiment is a motor which operates at a high rotational speed exceeding 30,000 rpm, for example, and degradation due to a temperature rise of the mechanical seal 30 becomes a problem. FIG. 9 illustrates a measurement result of use of a predetermined mechanical seal, and it can be understood that in a case where no cooling process is performed, as the motor speed becomes higher, the temperature of the mechanical seal rises. In FIG. 9, it can be understood that for example, at 30,000 rpm, the temperature of the mechanical seal exceeds the thermal resistant temperature Tr of the secondary seal.

Accordingly, in the present embodiment, a configuration is made such that when the seal temperature T of the mechanical seal 30 reaches the threshold value temperature Tth which is lower than the thermal resistant temperature Tr of the secondary seal 33 by the predetermined temperature, the coolant L at a lower temperature is supplied to the cooling jacket passage 25 and the seal temperature T of the mechanical seal 30 (particularly, the secondary seal 33) thereby does not reach the thermal resistant temperature Tr.

In a case where a negative determination is made in step S13 (No in S13), the controller 50 finishes the process. That is, during a period in which the seal temperature T of the mechanical seal 30 is low, the coolant L is supplied to the mechanical seal 30 without being cooled by the coolant heat exchange unit 45. Accordingly, an operation load of the compressor 63 or the like is reduced, and power saving can thereby be achieved.

On the other hand, in a case where an affirmative determination is made in step S13 (Yes in S13), the controller 50 switches a valve position Vs of each of the switching valves 44a and 44b to a valve position Vc for cooling (S14) and causes the coolant L to pass through the first branch channel 41a. Accordingly, the coolant L performs heat exchange with the refrigerant R in the coolant heat exchange unit 45 and is cooled. Consequently, because the coolant L which has been cooled by the refrigerant R is supplied to the cooling jacket passage 25, the mechanical seal 30 is more efficiently cooled, and the secondary seal 33 is thereby inhibited from reaching the thermal resistant temperature Tr.

Referring to the time chart in FIG. 10, the rotor 11 rotates from times t1 to t2, and in conjunction with this, a valve opening degree Vd of the delivery valve 46 is changed from a closed position (CL) to an open position (OP). However, because the seal temperature T of the mechanical seal 30 is low (T<Tth), the valve position Vs of each of the switching valves 44a and 44b is maintained in a bypassing position Pb.

Further, the rotor 11 rotates from other times t3 to t6, and in conjunction with this, the valve opening degree Vd of the delivery valve 46 is maintained in the open position (OP). In this period, when the seal temperature T of the mechanical seal 30 reaches the threshold value temperature Tth at a time t4, the valve position Vs of each of the switching valves 44a and 44b is switched from the bypassing position Pb to a cooling position Pc. Accordingly, the coolant L is cooled by the coolant heat exchange unit 45 after the time t4, and the coolant temperature TL lowers. Accompanying this, when the seal temperature T of the mechanical seal 30 lowers to a temperature lower than the threshold value temperature Tth at a time t5, the valve position Vs of each of the switching valves 44a and 44b is again switched to the bypassing position Pb.

### Modification Example of Cooling Jacket Passage

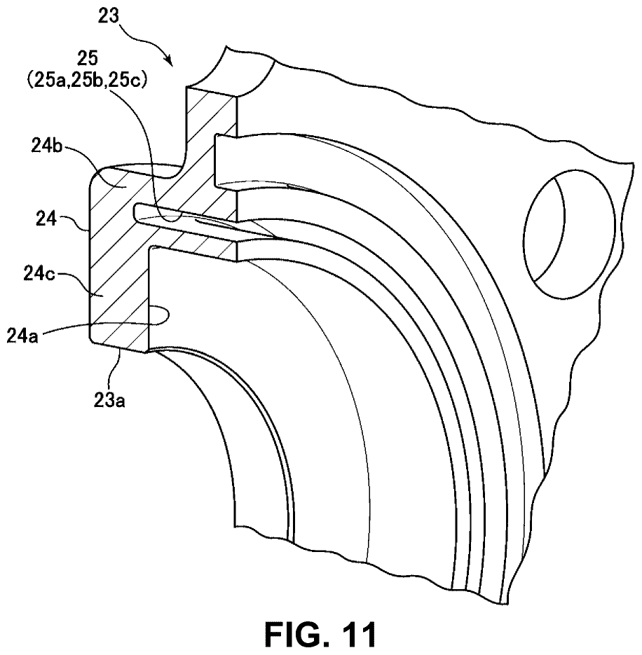

Next, an embodiment according to a modification example will be described with reference to FIG. 11. In the end cover 23 according to the modification example in FIG. 11, the entrance passage 25a and the exit passage 25b are connected together in the circumferential direction and are formed into an annular shape similarly to the annular cooling passage 25c. In such a configuration as well, similarly to a case illustrated in FIG. 4, the coolant L injected from the injection holes 20A reaches the entrance passage 25a through the separate internal channels 20b, passes, from the exit passage 25b, through the separate internal channel 20b in a lower area, and is discharged to the outside.

### Modification Example of Mounting Structure of Mechanical Seal

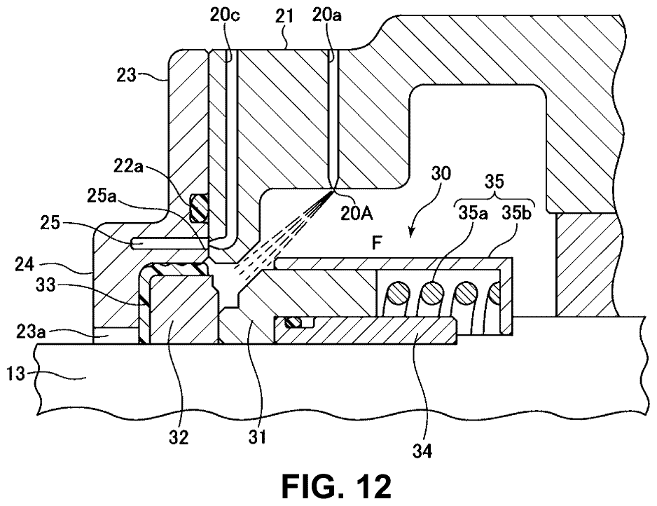

Next, an embodiment according to a modification example will be described with reference to FIG. 12. In an example in FIG. 12, in the housing 21, separately from the internal channels 20a which open to the seal arrangement space F, a second internal channel 20c is provided which branches from the internal channels 20a. The internal channel 20c directly communicates with the cooling jacket passage 25 and supplies the coolant L. In this embodiment, the internal channel 20a opens to the seal arrangement space F, and its injection hole 20A is formed to have such an injection pattern that the coolant L is directly blown or otherwise provided onto sliding portions. On the other hand, similarly to the internal channel 20a, the second internal channel 20c extends through the housing 21 but does not open to the seal arrangement space F and is directly coupled to the entrance passage 25a formed in the end cover 23. Accordingly, in this embodiment, the coolant L is directly supplied to the cooling jacket passage 25, and the mechanical seal 30 (particularly, the secondary seal 33) can more efficiently be cooled.

### Working and Effects

Next, working and effect of the motor system S according to the present embodiment will be described.

The motor system S according to the present embodiment is the motor system S for cooling the mechanical seal 30 provided for the rotating shaft 13 of the motor M, the motor system S including: the mechanical seal 30 that has the rotating ring 31 mounted on the rotating shaft 13 and the fixed ring 32 fixed to the casing 20 of the motor M via the secondary seal 33 and that is configured such that the rotating ring 31 and the fixed ring 32 abut each other at the predetermined pressure in the axis direction Y of the rotating shaft 13; the tank 42 for storing the coolant L to be supplied to the mechanical seal 30; the pump 43 for pressure-feeding the coolant L stored in a tank 2; the coolant channel 41 that guides the coolant L, which is pressure-fed by the pump 43, to the vicinity of the mechanical seal 30; and the refrigerant circulation circuit 60 that circulates the refrigerant R in the motor M and cools the motor M, characterized in that in the casing 20, the cooling jacket passage 25 is formed which is for causing the coolant L to flow passing through the vicinity of the fixed ring 32 and/or the secondary seal 33 and the coolant channel 41 has the coolant heat exchange unit 45 for performing heat exchange between the coolant L in the coolant channel 41 and the refrigerant R in the refrigerant circulation circuit 60 and is configured to guide the coolant L, which is cooled by the coolant heat exchange unit 45, to at least the cooling jacket passage 25.

In the present embodiment configured in such a manner, a configuration is made such that the cooling jacket passage 25 which causes the coolant L to pass therethrough for cooling the mechanical seal 30 is formed in the casing 20 and the casing 20 functions as a cooling jacket. In addition, in the present embodiment, a configuration is made such that in the coolant heat exchange unit 45, the coolant L, which has been cooled by the refrigerant R in the refrigerant circulation circuit 60 for cooling the motor M is guided to the cooling jacket passage 25. In such a configuration, in the present embodiment, the mechanical seal 30 can effectively be cooled, and degradation of the mechanical seal 30 can be inhibited.

Further, in the present embodiment, the coolant channel 41 is configured to guide the coolant L to the cooling jacket passage 25 and to blow the coolant L onto the mechanical seal 30. In the present embodiment configured in such a manner, cooling and lubrication of the mechanical seal 30 can be performed by the coolant L.

Further, in the present embodiment, the cooling jacket passage 25 has: the entrance passage 25a which extends from an inner side surface of the casing 20 along the axis direction Y and receives the coolant L; the cooling passage 25c which communicates with the entrance passage 25a, extends around the rotating shaft 13 in the casing 20, and causes the coolant L to pass through the cooling passage 25c; and the exit passage 25b which communicates with the cooling passage 25c and is for discharging the coolant L from the cooling passage 25c. In the present embodiment configured in such a manner, while stress concentration which can occur in the casing 20 is inhibited by formation of the cooling jacket passage 25, the mechanical seal 30 mounted on the casing 20 can be cooled by the coolant L which passes through the cooling jacket passage 25.

Further, in the present embodiment, the coolant L is lubricating oil. In the present embodiment configured in such a manner, because the coolant L for lubrication and cooling of the mechanical seal 30 can be supplied to the mechanical seal 30 by using a common channel, a device configuration can be simplified.

Further, in the present embodiment, the refrigerant R is a CO₂ refrigerant. In the present embodiment configured in such a manner, an environmental load can be decreased by using a natural refrigerant.

Further, in the present embodiment, the refrigerant R is, together with the coolant L, stored in the tank 42, and the refrigerant circulation circuit 60 includes the compressor 63 which compresses the refrigerant R supplied from the tank 42, the heat exchanger 64 which causes the compressed refrigerant R to dissipate heat, and the expansion valves 67a and 67b which expand the refrigerant R resulting from heat dissipation and is configured to supply the expanded refrigerant R to the motor M and the coolant heat exchange unit 45. In the present embodiment configured in such a manner, the refrigerant R in a low temperature state can be generated by the refrigerant circulation circuit 60, and the coolant L can effectively be cooled in the coolant heat exchange unit 45.

Further, in the present embodiment, expansion valves include at least the first expansion valve 67a and the second expansion valve 67b, and the refrigerant circulation circuit 60 branches into the first expansion valve 67a and the second expansion valve 67b in a downstream portion relative to the heat exchanger 64 and is configured such that the refrigerant R expanded by the first expansion valve 67a is supplied to the motor M and the refrigerant R expanded by the second expansion valve 67b is supplied to the coolant heat exchange unit 45. In the present embodiment configured in such a manner, cooling of the motor M and cooling of the coolant L in the coolant heat exchange unit 45 can effectively be performed.

Further, in the present embodiment, the coolant channel 41 includes the first branch channel 41a which passes through the coolant heat exchange unit 45, the second branch channel 41b which bypasses the coolant heat exchange unit 45, and the switching valves 44a and 44b which selectively switch the first branch channel 41a and the second branch channel 41b, the motor system S further includes the temperature sensor 49 that measures the temperature T of the mechanical seal 30 and the controller 50 that controls the switching valves 44a and 44b, and the controller 50 is configured to control the switching valves 44a and 44b such that the coolant L passes through the first branch channel 41a in a case where the temperature T measured by the temperature sensor 49 is equal to or higher than the predetermined threshold value temperature Tth (Yes in S13). In the present embodiment configured in such a manner, when the temperature T of the mechanical seal 30 is low and cooling of the coolant L by the refrigerant R is not necessary, an operation load of the refrigerant circulation circuit 60 is reduced, and power saving can thereby be achieved.

### REFERENCE SIGNS LIST

13 rotating shaft
20 casing
20a, 20b, 20c internal channel
21 housing
23 end cover
24 bulging portion
25 cooling jacket passage
25a entrance passage
25b exit passage
25c cooling passage
30 mechanical seal
31 rotating ring
32 fixed ring
33 secondary seal
40 coolant circulation circuit
41 channel (coolant channel)
45 coolant heat exchange unit
60 refrigerant circulation circuit
61 channel
F seal arrangement space
L coolant
M motor
R refrigerant
S motor system

1. A motor system for cooling a mechanical seal provided for a rotating shaft of a motor, the motor system comprising:
a mechanical seal that has a rotating ring mounted on the rotating shaft and a fixed ring fixed to a casing of the motor via a secondary seal and that is configured such that the rotating ring and the fixed ring abut each other at predetermined pressure in an axis direction of the rotating shaft;
a tank in which a coolant to be supplied to the mechanical seal is stored;
a pump configured to pressure-feed the coolant stored in the tank;
a coolant channel that guides the coolant, which is pressure-fed by the pump, to a vicinity of the mechanical seal; and
a refrigerant circulation circuit that circulates a refrigerant in the motor and cools the motor, wherein
the casing includes a cooling jacket passage, the cooling jacket passage being configured to cause the coolant to flow through a vicinity of the fixed ring and/or the secondary seal, and
the coolant channel includes a coolant heat exchanger configured to perform heat exchange between the coolant in the coolant channel and the refrigerant in the refrigerant circulation circuit and is configured to guide the coolant, which is cooled by the coolant heat exchanger, to at least the cooling jacket passage.

2. The motor system according to claim 1, wherein the coolant channel is configured to guide the coolant to the cooling jacket passage and to blow the coolant onto the mechanical seal.

3. The motor system according to claim 1, wherein the cooling jacket passage has:
an entrance passage that extends from an inner side surface of the casing along the axis direction and receives the coolant;
a cooling passage in fluid communication with the entrance passage, extending around the rotating shaft in the casing, and being configured to cause the coolant to pass through the cooling passage; and
an exit passage in fluid communication with the cooling passage and being configured to discharge the coolant from the cooling passage.

4. The motor system according to claim 1, wherein the coolant is lubricating oil.

5. The motor system according to claim 2, wherein the coolant is lubricating oil.

6. The motor system according to claim 3, wherein the coolant is lubricating oil.

7. The motor system according to claim 1, wherein the refrigerant is a CO₂ refrigerant.

8. The motor system according to claim 7, wherein:
the refrigerant is stored in the tank together with the coolant, and
the refrigerant circulation circuit includes a compressor configured to compresses the refrigerant supplied from the tank, a heat exchanger configured to cause the compressed refrigerant to dissipate heat, and an expansion valve configured to expand the refrigerant resulting from heat dissipation and configured to supply the expanded refrigerant to the motor and the coolant heat exchange unit.

9. The motor system according to claim 8, wherein:
the expansion valve includes at least a first expansion valve and a second expansion valve, and
the refrigerant circulation circuit branches into the first expansion valve and the second expansion valve in a downstream portion relative to the heat exchanger and is configured such that the refrigerant expanded by the first expansion valve is supplied to the motor and the refrigerant expanded by the second expansion valve is supplied to the coolant heat exchange unit.

10. The motor system according to claim 1, wherein:
the coolant channel includes a first branch channel which passes through the coolant heat exchange unit, a second branch channel which bypasses the coolant heat exchange unit, and a switching valve which selectively switches the first branch channel and the second branch channel,
the motor system further includes a temperature sensor configured to measure a temperature of the mechanical seal and a controller configured to control the switching valve such that the coolant passes through the second branch channel in a case where the temperature measured by the temperature sensor is equal to or higher than a predetermined threshold value temperature.
